(19) United States
(12) Patent Application Publication
(10) Pub. No.: US 2002/0153292 A1
(43) Pub. Date: Oct. 24, 2002

(54) Method for sorting, counting and validating articles, in particular pharmaceuticals

(76) Inventor: Giuseppe Monti, Pianoro (IT)

Correspondence Address: William J. Sapone, Esq., Coleman Sudol Sapone P.C., 714 Colorado Ave., Bridgeport, CT, 06605, US

(21) Appl. No.: 10/123,575

(22) Filed: Apr. 15, 2002

(30) Foreign Application Priority Data
Apr. 18, 2001 (IT) B02001A 000230

(51) Int. Cl. B07C 5/00

(52) U.S. Cl. 209/577; 209/587; 209/638; 209/939

(57) ABSTRACT

A method is proposed for selecting, counting, and validating articles, in particular pharmaceuticals, which method is based on considering the articles, moved in a continuous flow, as non-integral until the integrity characteristics are detected by detecting means. The detection operates deflecting means for deviating the integral articles to pre-selected containers.

### FIELD OF THE INVENTION

The present invention relates to the technical field concerning machines for sorting and counting articles, in particular pharmaceutical articles, such as e.g. tablets, coated pills, capsules and the like.

In this specific case, the present invention relates to a method for sorting, counting and validating these articles.

### DESCRIPTION OF THE PRIOR ART

Counting machines have the task of counting, precisely and reliably, articles to be introduced in containers or bottles, ensuring that a predetermined number of articles, preferably all of them in integral condition, are contained in each bottle.

In accordance with known operation modes, the counting machines include vibrating conveyors, e.g. arranged in a series, defining a plurality of “V”-like channels, which introduce the articles being handled into a multi-grooved hopper, equipped with suitable choke means, situated near each groove as well as near the final outlet.

The pre-selected number of articles, which only theoretically are introduced into the bottles passing, one after another, in front of the hopper outlet section, moved by e.g. conveying belt, is determined in relation to the count of each choke means connected to the corresponding groove.

Actually, the above machines are not able to determine the precise number of articles introduced into the bottles, since before being introduced into the bottles, the articles are held in a collecting chamber made in the hopper, near the outlet section thereof.

Moreover, the integrity of articles introduced into each bottle is not verified in any way.

Another problem of the above mentioned counting machines derives from the fact that they need a long non-operating time necessary to replace filled containers with empty ones for receiving integral articles.

During the stops, the choke means connected to the hopper outlet section cut off the articles flow, so that the current containers are filled in accordance with the selected characteristics before being substituted with new empty containers.

However, it is to be pointed out that the multiple-groove conveying system requires more maintaining operations and its installation, managing, cleaning and control system are very expensive.

There are also other sorting machines, which include vibrating conveyors, defining at least one conveying channel, which moves orderly the articles coming from the collecting container, where they are kept in bulk, toward a falling section, where the articles are let fall freely due to the gravity, up to a predetermined level.

Detecting means, including suitable sensors or video cameras, are connected to known systems of image processing and control, associated to corresponding deflector means.

The deflector means send the analyzed articles toward suitable containers for integral or non-integral articles, in relation to the signals coming from the processing and control means.

Most of the sorting machines operate in accordance with to a widely known rule, i.e. the deflector means do not intervene if the article analyzed by the detecting means is integral, thus acceptable.

Therefore, the integral article is introduced undisturbed into the corresponding container with integral articles.

Otherwise, if the detecting means detect predetermined lacks in the tested article, the deflector means deflect the article toward the containers with non-integral articles.

As a result, the system for control of articles to be sorted considers the articles integral until possible faults are detected by the detecting means, and consequently, the deflector means are operated to send non-integral articles to different containers, provided for this purpose.

### SUMMARY OF THE INVENTION

The object of the present invention is to propose a method for sorting, counting and validating articles, in particular pharmaceuticals, which ensures filling of corresponding containers with a predetermined number of articles, each of which is validated as integral, in relation to predetermined validation criterion, thus ensuring highest production rate of the production line.

Another object of the present invention is to propose a method, which can be used to sort and count articles fed in a continuous flow.

A further object of the present invention is to propose a method with working steps particularly simple and easy conceivable, and which ensures high reliability in each working conditions, independently from the articles size.

The above-mentioned objects are obtained in accordance with the content of the claims, by means of a method for sorting and counting articles, in particular pharmaceutical articles, including following steps:

moving articles in a forward movement direction along a conveying line, the conveying line defining at least one conveying channel for conveying said articles;

creating a continuous flow of said articles and making said flow of articles fall freely after exiting from said conveying channel;

checking the integrity of each article of said continuous flow by detecting means, situated along the continuous flow and connected to at least one control unit for processing information;

freely introducing articles found by said detecting means as non-integral, into collecting means;

activating, by said control unit and in step relation with said detecting means, deflector means, situated downstream of said detecting means with respect to said flow, for deviating articles found as integral, from the continuous flow and into a container until a selected number of said integral articles is reached;

activating, by said control unit and in step relation with filling up of said container, of said deflector means to deviate articles found as integral, from the continuous flow into an empty container.

### BRIEF DESCRIPTION OF THE DRAWINGS

The characteristic features of the present invention will be pointed out in the following description of a preferred, but not only embodiment, with reference to the enclosed drawings, in which:

FIG. 1 is a schematic lateral view of an apparatus, which carries out the proposed method;

FIG. 2 is a schematic top view of the conveying line connected to the apparatus shown in FIG. 1.

### DESCRIPTION OF THE PREFERRED EMBODIMENTS

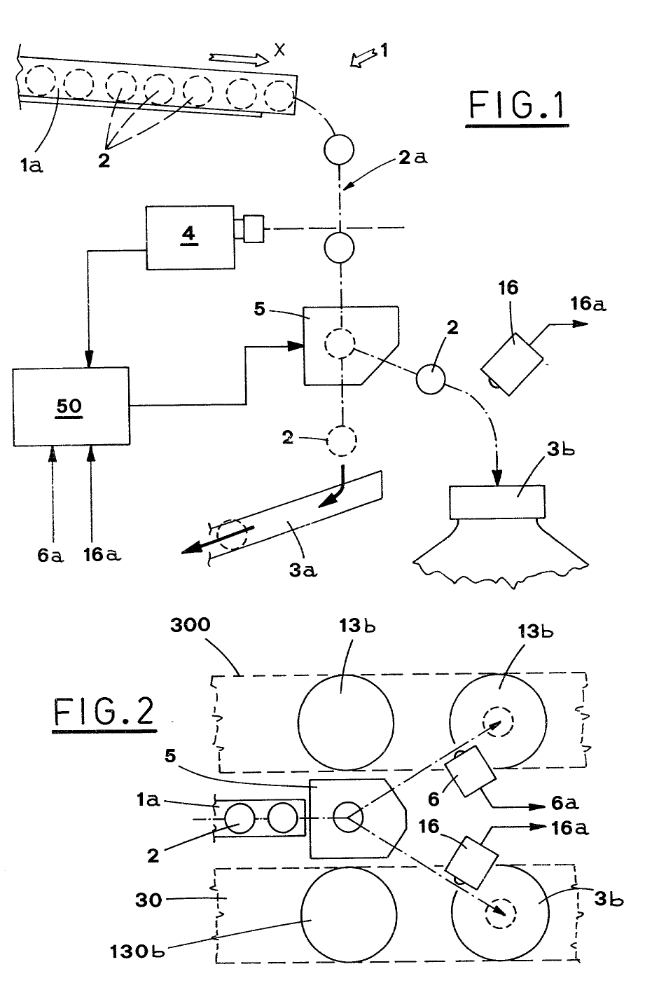

With reference to the above drawings, reference numeral 1 indicates a conveying line, advantageously including a vibrating conveyor, which defines at least one conveying channel 1a containing pharmaceutical articles 2, such as e.g. tablets, coated pills, capsules and the like, which are moved in a forward movement direction X (FIG. 1).

After being moved inside the conveying channel 1a, a continuous flow 2a of the articles 2 is created and the articles, getting out of the conveying channel 1a, fall freely.

Due to gravity acceleration, the freely falling articles 2 are suitably distanced one from another, so that suitable detecting means 4 can verify the article integrity.

The detecting means include e.g. a video camera situated along the continuous flow 2a, downstream of the conveying channel 1a with respect to the latter.

The data obtained by the detecting means 4 are processed in a commonly known way, by a control unit 50 for processing information.

If, according to predetermined parameters, the video camera 4 finds the articles 2 of the continuous flow 2a non-integral, they are introduced into collecting means 3a, situated below, e.g. collecting containers or channels leading away, maintaining the free fall trajectory (FIG. 1).

If an article 2 of the continuous flow 2a is found integral, the control unit 50 activates, in phase relation with the video camera 4 operation, the deflector means 5, which is situated downstream of the video camera 4 and deviate the article 2 from the continuous flow 2a into a container 3b.

The containers 3b for receiving articles 2 which have been found integral by the video camera 4, i.e. articles deflected by the deflector means 5, are situated on a line 30 for conveying the containers 3b.

The checking operation of the number of integral articles 2 introduced into the container 3b is advantageously performed by sensor means 6 situated near the opening of the container 3b, downstream of the deflector means 5 with respect to the continuous flow 2a of articles.

The sensor means 6, e.g. photocell or infrared means, ensure the detection of the passage of each article 2 deflected by the deflector means 5, that is found integral, into the relative container 3b.

In combination with the operation of the control unit 50, these detections permit the counting of the articles 2 which actually enter the same container 3b.

Therefore, each container 3b is surely filled with a predetermined number of integral articles 2, this providing a validation of the number of integral articles 2 present in each container 3b filled in this way.

After a selected container 3b has been filled with a predetermined number of articles 2, the deflector means 5 deflect the integral articles 2 toward an empty container 13b.

If it is not necessary to certify the number of integral articles 2 present in each container 3b, it is possible to calculate the number of integral articles 2, which are introduced into the container 3b, by counting how many times the deflector means 5, have been operated.

According to a preferred embodiment, which optimizes the proposed method, a couple of conveying lines, first 30 and second 300, for containers 3b, are positioned along the sides of the conveying channel 1a, substantially symmetrical therewith, to receive integral articles 2 deflected by deflecting means 5 (FIG. 2).

Each of the conveying lines 30, 300, preferably operated stepwise, is activated to fill the predetermined container 3b and place a subsequent empty container 130b, 13b in a filling position.

Thus, it is possible to manage the continuous flow 2a of articles 2 in best way, filling first the predetermined container 3b of the first conveying line 30 with a fixed number of integral articles 2, and then a second empty container 13b placed on the second conveying line 300 situated therebeside.

What above takes place without cutting off the continuous flow 2a of articles 2 falling freely from the conveying channel 1a.

During the waiting time necessary for the first conveying line 30 to substitute the filled container 3b with a third empty container 130b, the second empty container 13b placed on the second conveying lines 300 is filled.

The sensor means 16, 6, associated to the containers 3b placed on each of the conveying lines 30, 300, detect the passage of the articles 2 deflected by the deflecting means 5, which are actually introduced into the corresponding containers 3b.

The proposed method for sorting, counting and validating articles, in particular pharmaceutical products, allows to fill containers, i.e. bottles, with a prefixed number of articles, each of which is validated as integral according to pre-established validation criterion.

A new notion of validation of articles is introduced, according to which the deflecting means deflect an article from the continuous flow only if the articles is validated as integral by the detecting means.

Otherwise, the article, which the detecting means found as non integral according to the validation criterion, is introduced normally into the corresponding collecting means 3a, e.g. collecting containers or a channel leading away, without interrupting the course.

The articles of the flow, in this case a continuous flow, are considered non-integral until the detecting means detect the integrity characteristics, and consequently, the deflecting means are operated to send the entire articles to pre-established containers.

Therefore, there is no possibility that a non-integral article can be introduced into the container aimed at receiving integral articles.

The possibility to work with continuous flows of articles, non choked by any intercepting means, ensures highest production rate of the associated production line.

The above-mentioned advantages are obtained by a method, whose working steps are simple and easy to conceive, and which ensures high reliability in each working conditions.

What is claimed is:

1. A method for sorting and counting articles, in particular pharmaceutical articles, including following steps:
moving articles in a forward movement direction along a conveying line, the conveying line defining at least one conveying channel for conveying said articles;
creating a continuous flow of said articles and making said flow of articles fall freely after exiting from said conveying channel;
checking the integrity of each article of said continuous flow by detecting means, situated along the continuous flow and connected to at least one control unit for processing information;
freely introducing articles found by said detecting means as non-integral, into collecting means;
activating, by said control unit and in step relation with said detecting means, deflector means, situated downstream of said detecting means with respect to said flow, for deviating articles found as integral, from the continuous flow and into a container until a selected number of said integral articles is reached;
activating, by said control unit and in step relation with filling up of said container, of said deflector means to deviate articles found as integral, from the continuous flow into an empty container.

2. A method as in claim 1, further including a working step in which the number of integral articles introduced into said container is validated by sensor means situated near the opening of said container, downstream of the deflector means with respect to said continuous flow;
with said sensor means detecting the passage of each article deviated by the deflector means, subsequently validated as integral by said detecting means, and actually introduced into said container.

3. A method as in claim 1, wherein a couple of conveying lines, first and second, for conveying containers, are situated along the sides of said conveying channel, substantially symmetrical therewith, for receiving said integral articles deviated by said deflector means; each of said conveying lines being activated to fill the predetermined container and place a subsequent empty container in filling position.

4. A method as in claim 1 wherein said detecting means are situated downstream of said conveying channel with respect to said flow of articles.
